(19) United States
(12) Patent Application Publication
(10) Pub. No.: US 2026/0021663 A1
(43) Pub. Date: Jan. 22, 2026

(54) CARTRIDGE

(71) Applicant: CANON KABUSHIKI KAISHA, Tokyo (JP)

(72) Inventors: NARUMI SHINOHARA, Kanagawa (JP); MITSURU CHIDA, Kanagawa (JP); JUNICHIRO IRI, Kanagawa (JP)

(21) Appl. No.: 19/267,371

(22) Filed: Jul. 11, 2025

(30) Foreign Application Priority Data
Jul. 17, 2024 (JP) 2024-114266

(51) Int. Cl. B41J 2/175

(52) U.S. Cl. CPC B41J 2/17513; B41J 2/17536; B41J 2/17553; B41J 2/17559; B41J 2002/17516

(57) ABSTRACT

A cartridge includes: a liquid storing bag; a casing including a storage portion for storing the liquid storing bag; a sealing member configured to seal an opening of the enclosure, and the cartridge supplies liquid in the liquid storing bag to outside. The storage portion has a first inner wall surface and a second inner wall surface. The liquid storing bag includes: a first welded portion facing the first inner wall surface; a second welded portion facing the second inner wall surface; and an outlet provided in the first welded portion to guide the liquid to the outside. The outlet is fixed to the first inner wall surface, and the second inner wall surface is provided with a first restricting portion projecting toward the storage portion and restricting a movement of the second welded portion toward the sealing member between the second welded portion and the seal member.

### BACKGROUND

### Field of the Technology

The present disclosure relates to a cartridge that stores a liquid.

### Description of the Related Art

An inkjet recording apparatus is installed with a cartridge that stores ink, and performs recording on a recording medium such as paper by supplying the ink from the cartridge to a recording head, and causing the recording head to eject the ink onto the recording medium. A cartridge is a liquid storing container for storing ink to be supplied to a recording head, and is attachable to and detachable from the recording apparatus. Some cartridges have a casing where an ink bag made of an elastic material is stored, and is configured to hold the ink inside the ink bag. For example, in the cartridge disclosed in Japanese Patent Application Laid-open No. 2016-187877, an ink bag is stored inside a first casing which has a box-like shape, and one side of which has an opening, and moreover, in which a film is air-tightly bonded to the end face of the opening of the first casing, to form a sealed space inside the first casing, and a second casing is attached so as to cover the film.

The ink bag is formed by welding together films made of an elastic material along peripheral edges thereof. The welded portion forms a projection projecting outward from a bag portion where the ink is stored. Although this welded portion cannot hold ink, the shape of the welded portion defines the outer shape of the ink bag. Because the casing for storing the ink bag also requires a space for storing the welded portion, this welded portion becomes a factor that reduces the ratio (volume efficiency) of an amount of ink that can be stored, relative to the volume of the casing.

### SUMMARY

In order to improve the volume efficiency, it is conceivable that the welded portion may be folded before being stored inside the casing. However, in conjunction with ink consumption, the ink bag inside the casing may deform, and the welded portion having been folded may come into contact with the film, which seals the casing, and this may damage the film.

The present disclosure is directed to the technology to suppress the welded portion of a liquid storing bag having the welded portion folded, from coming into contact with a sealing member providing sealing to a casing of a cartridge, with the liquid storing bag being stored, even if the liquid storing bag deforms in conjunction with ink consumption.

A cartridge according to the present disclosure includes:
a liquid storing bag formed by welding an elastic member into a bag-like shape;
a casing including a storage portion enabled to store the liquid storing bag; and
a sealing member configured to seal an opening of the storage portion,
wherein the cartridge is enabled to supply liquid stored in the liquid storing bag to outside,
wherein the storage portion has a first inner wall surface and a second inner wall surface facing the first inner wall surface,
wherein the liquid storing bag includes:
   a first welded portion formed to be provided to a first side facing the first inner wall surface;
   a second welded portion formed to be provided to a second side facing the second inner wall surface; and
   an outlet provided in the first welded portion and enabled to guide the liquid to the outside,
wherein the outlet is fixed to the first inner wall surface, and
wherein the second inner wall surface is provided with a first restricting portion projecting toward an inner side of the storage portion, and interposed between the second welded portion and the sealing member, and moreover configured to restrict a movement of the second welded portion toward the sealing member.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view of a cartridge according to a first embodiment.

FIG. 2 is an exploded view of the cartridge according to the first embodiment.

FIG. 3 is a perspective view illustrating an internal structure of the cartridge according to the first embodiment.

FIG. 4 is a cross-sectional view of the cartridge according to the first embodiment.

FIG. 5 is a top view illustrating an internal structure of a cartridge according to a second embodiment.

FIG. 6 is a cross-sectional view of a cartridge according to a third embodiment.

FIG. 7 is a cross-sectional view of a cartridge according to a fourth embodiment.

FIG. 8 is an exploded view of the cartridge according to the fourth embodiment.

### DESCRIPTION OF THE EMBODIMENTS

Exemplary embodiments for carrying out the present disclosure will now be explained with reference to drawings. However, the dimensions, materials, shapes, relative positioning, and the like of the components described in the following embodiments may be modified as appropriate depending on the configuration and various conditions of the device to which the present disclosure is applied, and the following embodiments are not intended to limit the scope of the present disclosure thereto. In the following description, components having the same function are given the same reference numerals in the drawings, and description thereof are sometimes omitted.

### First Embodiment

A cartridge according to a first embodiment is used as an ink tank to be attached to a liquid ejection apparatus such as an inkjet printer. The ink according to the first embodiment is one example of liquid that can be contained in the cartridge according to the present disclosure, and the cartridge according to the present disclosure is not limited to that for the ink, but is also applicable to those for liquids other than the ink.

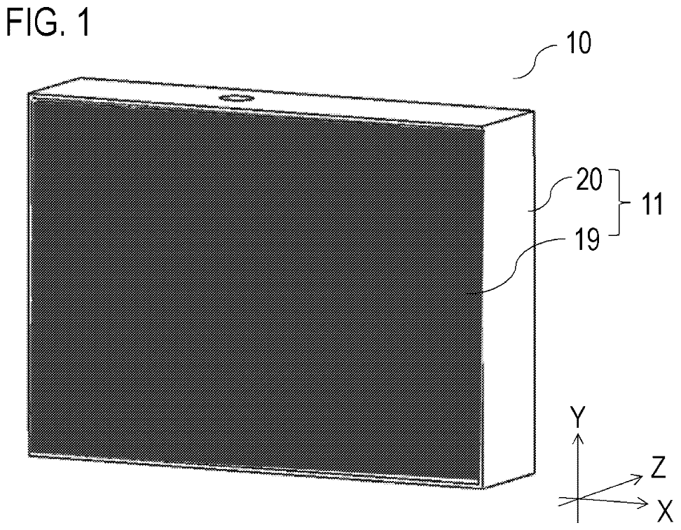

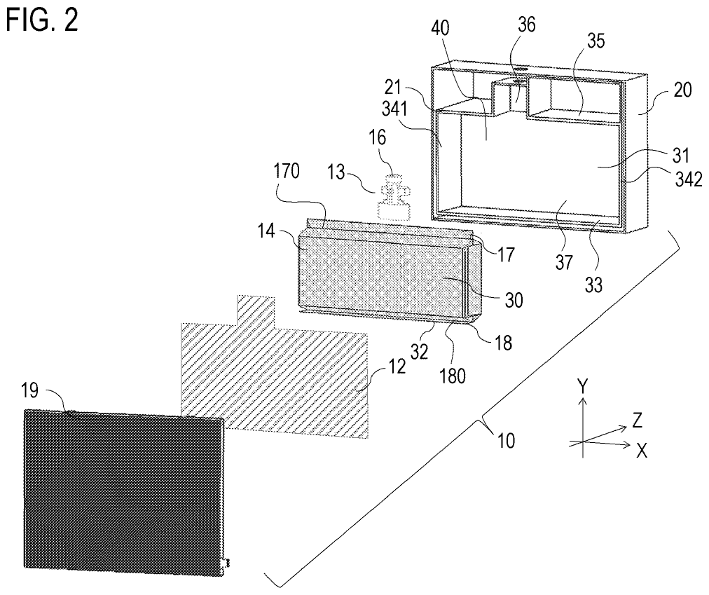

FIG. 1 is a perspective view of a cartridge 10 according to the first embodiment. FIG. 2 is an exploded view of the cartridge 10 according to the first embodiment. In the following description, the longitudinal direction of the cartridge 10 is defined as the X direction, the transverse direction is defined as the Y direction, and the thickness direction is defined as the Z direction. The cartridge 10 has a substantially cuboid shape, and the X, Y, and Z directions are orthogonal to one another. Note that the shape of the cartridge 10 described in the first embodiment is one example, and the shape of the cartridge according to the present disclosure is not limited to a cuboid shape. In FIG. 2, a restricting portion 15, which will be described later, is not illustrated.

The cartridge 10 includes a housing 11 where an ink bag 14 that is a liquid storing bag for storing ink is stored, and a film-like sealing member 12 that is provided inside the housing 11. One example of the material of the housing 11 is resin. The housing 11 includes a box-shaped casing 20 one side of which in the Z direction has an opening, and a cover 19 which is a lid member covering the opening of the casing 20. The cartridge 10 is enabled to supply ink, which is the liquid stored in the ink bag 14, to the outside.

The casing 20 has a storage portion 31 enabled to store the ink bag 14. The storage portion 31 has an opening 40 on one side, in the thickness direction (Z direction) of the ink bag 14. The sealing member 12 seals the opening 40 of the storage portion 31 provided to the casing 20. The storage portion 31 has an upper wall 35 as a first inner wall surface, and a lower wall 33 as a second inner wall surface facing the first inner wall surface. The storage portion 31 has a first side wall 341 as a third inner wall surface extending in a direction intersecting with the upper wall 35 and the lower wall 33, and a second side wall 342 that is a fourth inner wall surface facing the first side wall 341.

The ink bag 14 is a liquid storing bag the bag-like shape of which is formed by bonding an elastic material by thermal fusion welding, for example. The overall shape of the ink bag 14 is substantially rectangular, and a first welded portion 17 is on a first side 170 extending along the X direction, and a second welded portion 18 is on a second side 180 on the opposite side of the first side 170 in the Y direction. The first side 170 of the ink bag 14 is disposed facing the upper wall 35 of the casing 20, and the second side 180 is disposed facing the lower wall 33 of the casing 20. To the first welded portion 17, a channel forming member 13 having an outlet 16 enabled to guide the liquid to the outside is welded.

The first welded portion 17 and the second welded portion 18 are formed as a result of welding the elastic material, and are flat projecting portions projecting outward (in the Y direction) from a bag portion 30 where the ink is stored. The first welded portion 17 and the second welded portion 18 are parts of the ink bag 14 where ink cannot be stored, but define the outer shape of the ink bag 14. The storage portion 31 where the ink bag 14 is stored inside the casing 20 has a volume allowing the first welded portion 17 and the second welded portion 18 to be stored.

To make the volume of the storage portion 31 small, the ink bag 14 stored inside the storage portion 31 has the second welded portion 18 folded along the second side 180 toward the sealing member 12 in the Z direction, as illustrated in FIG. 2. Therefore, a tip 32 of the second welded portion 18 extends from the bag portion 30 toward the sealing member 12 in a direction parallel with the Z direction, or in a direction near parallel with the Z direction, inside the housing 11.

The storage portion 31 has a box-like shape formed by the lower wall 33, the first side wall 341, the second side wall 342, the upper wall 35, and a bottom wall 37, and enabled to store the ink bag 14. The lower wall 33 and the upper wall 35 face each other in the Y direction, and each of the lower wall 33 and the upper wall 35 has a planar shape extending along the XZ directions. The first side wall 341 and the second side wall 342 face each other in the X direction, and each of the first side wall 341 and the second side wall 342 has a planar shape extending along the YZ directions. The bottom wall 37 has a planar shape extending along the XY directions. The upper wall 35 has a recessed portion 36 at the center in the X direction, and the channel forming member 13 is stored inside the recessed portion 36. The channel forming member 13 is fixed to the upper wall 35 of the casing 20 by snap-fitting or press-fitting.

The elastic member forming the ink bag 14 has a layered structure including a highly elastic material that is easily deformable, so as to enable the liquid to be used up more completely. The elastic material may have a layered structure including nylon for enhancing the impact resistance, an aluminum layer for preventing evaporation of the liquid, and a polyethylene film that is a highly elastic material, for example.

The channel forming member 13 may be made of the same material as the material of the innermost layer of the ink bag 14. With this, the channel forming member 13 can be welded to the ink bag 14 by thermal fusion welding, for example. Furthermore, by providing the ink bag 14 with a gusseted-bag shape, the volume can be increased.

The sealing member 12 is welded to an end face 21 around the opening 40 of the casing 20 (an end face perpendicular to the Z direction). With this, the storage portion 31, which is an area where the ink bag 14 is held inside the casing 20, becomes a sealed space.

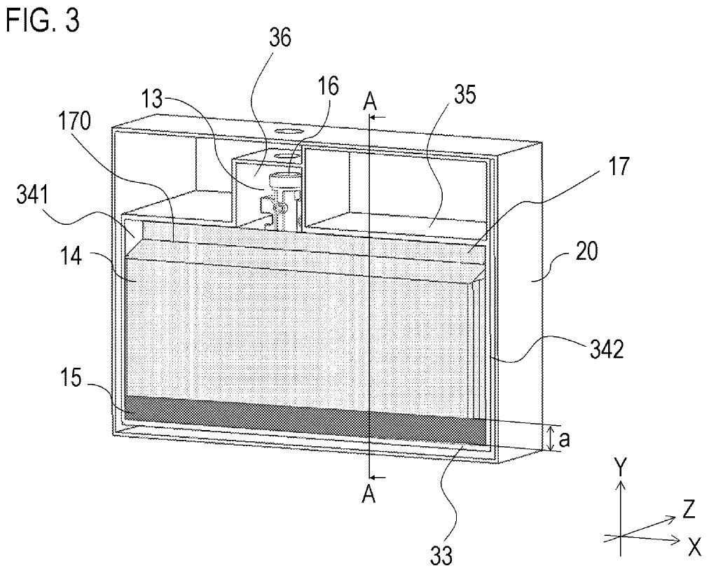

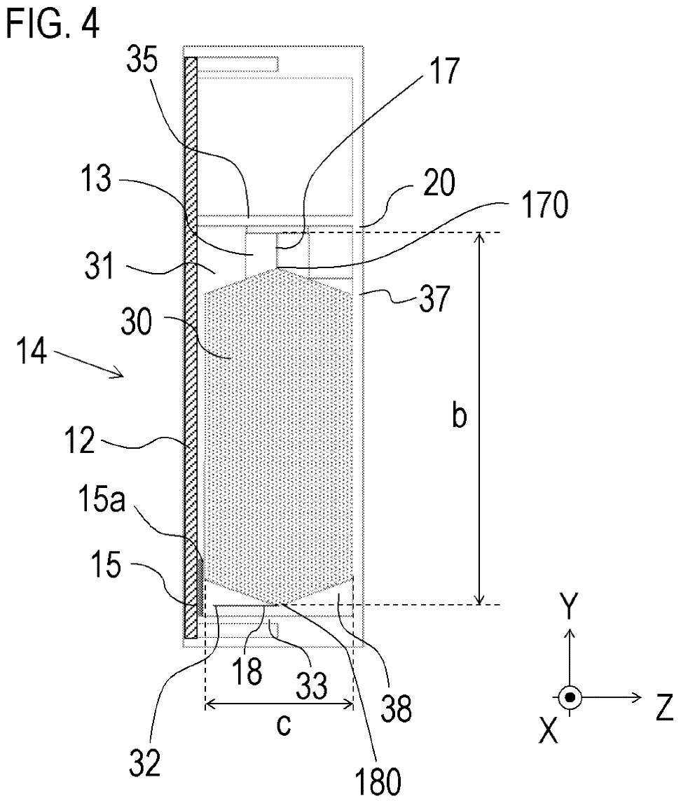

FIG. 3 is a perspective view illustrating an internal structure of the cartridge 10 according to the first embodiment. FIG. 4 is a cross-sectional view of the cartridge 10 taken along line AA in FIG. 3. In FIG. 3, the sealing member 12 and the cover 19 are not illustrated. In FIG. 4, the cover 19 is not illustrated.

The lower wall 33 is provided with a restricting portion 15 projecting from one end portion of the lower wall 33 in the Z direction (the end portion on the side of the sealing member 12) toward the inner side of the storage portion 31 in the Y direction. The restricting portion 15 has an overhang-like shape extending from the lower wall 33. In other words, a recessed portion 38 is formed by the restricting portion 15, the lower wall 33, and a lower part of the bottom wall 37 (a part near the lower wall 33 in the Y direction). The depth of the recessed portion 38 in the Y direction is defined by the width of the restricting portion 15 in the Y direction. The recessed portion 38 holds a lower part of the ink bag 14 (a part nearer to the lower wall 33 in the Y direction). As a result, as illustrated in FIG. 4, the restricting portion 15 is interposed between the tip 32 of the second welded portion 18 and the sealing member 12, and restricts the movement of the second welded portion 18 toward the sealing member 12.

Because the channel forming member 13 provided to the first welded portion 17 of the ink bag 14 is fixed to the casing 20, as the ink bag 14 moves inside the storage portion 31 of the casing 20 or the ink bag 14 deforms as the ink is consumed, the second welded portion 18 on the opposite side of the first welded portion 17 moves. Even in such a case, the tip 32 of the second welded portion 18 comes into abutment against the restricting portion 15, and is restricted from moving toward the sealing member 12. With this, it is possible to reduce the risk of the tip 32 of the second welded portion 18 coming into contact with the sealing member 12 and damaging the sealing member 12.

As long as the width a of the restricting portion 15 in the Y direction is equal to or greater than the thickness of the second welded portion 18 in a state of being folded (the size in the Y direction), the restricting portion 15 can suppress the movement of the tip 32 toward the sealing member 12. In other words, the restricting portion 15 is projecting further toward the upper wall 35 (toward the side of the first inner wall surface) than the position of the tip 32 of the second welded portion 18 that is folded toward the sealing member 12. In addition, the width a of the restricting portion 15 in the Y direction may be greater than the size of the range where the tip 32 of the second welded portion 18 is movable in the Y direction.

Because the channel forming member 13 provided to the first welded portion 17 of the ink bag 14 is fixed to the casing 20, the ink bag 14 may deform in a manner warping toward the sealing member 12, as the ink becomes consumed. Denoting the movable range of the tip 32 of the second welded portion 18 in the Y direction due to such warpage as d, by setting the width a of the restricting portion 15 in the Y direction to a size equal to or greater than d (d≤a), it is possible to reduce the risk of the tip 32 coming into contact with the sealing member 12, as a result of such warpage.

Furthermore, because the restricting portion 15 is provided, in order to attach the ink bag 14 to the casing 20, an operation of inserting the ink bag 14 into the recessed portion 38 formed by the restricting portion 15 is performed. To ensure the case of this operation, a gap larger than at least the size of the ink bag 14 in the thickness direction (Z direction) may be ensured between an end portion 15a of the restricting portion 15 in the Y direction and the upper wall 35. That is, when b denotes the size of the ink bag 14 in the transverse direction (Y direction), and c denotes the thickness of the ink bag 14 (the size in the Z direction), a≤b−c may be satisfied.

As one example, the outer dimension of the casing 20 in the X direction was set to 120 mm, the dimension in the Y direction was set to 85 mm, and the dimension in the Z direction was set to 25 mm. The length a of the restricting portion 15 extending from the lower wall 33 in the Y direction was set to 7 mm. For the ink bag 14 held inside the storage portion 31 of the casing 20, the size in the X direction was set to 110 mm, the size b in the Y direction was set to 55 mm, and the size c in the Z direction was set to 20 mm. The width of the first welded portion 17 of the ink bag 14 was set to 5 mm, and the width of the second welded portion 18 was set to 10 mm. In this case, d was 2 mm. The width a of the restricting portion 15 satisfies 2 mm≤a≤35 mm.

By providing the casing 20 with the restricting portion 15, the following effects can be achieved.

When the second welded portion 18 of the ink bag 14 is folded and stored inside the casing 20 of the housing 11, the tip 32 of the second welded portion 18 comes into abutment against the restricting portion 15, so that the risk of the tip 32 reaching the sealing member 12 can be suppressed. In this manner, it is possible to suppress damages of the sealing member 12.

When the ink bag 14 is to deform in a manner warping toward the sealing member 12, as a result of the ink inside the ink bag 14 being consumed, a part of the ink bag 14 near the second welded portion 18 comes into abutment against the restricting portion 15, so that warping deformation can be suppressed.

By providing the restricting portion 15 with a planar shape extending in the XY direction, the sealing member 12 can be welded thereto. Therefore, the sealing member 12 can be welded more firmly to the casing 20, compared with a configuration in which the sealing member 12 is welded only to the end face 21 of the casing 20.

Although described in the first embodiment is an example in which the restricting portion 15 is provided continuously across the entire area in the X direction along the second side 180, the restricting portion 15 may also be provided to a part in the X direction. Furthermore, the restricting portion 15 may be provided in a plurality along the second side 180, with a space therebetween in the X direction.

### Second Embodiment

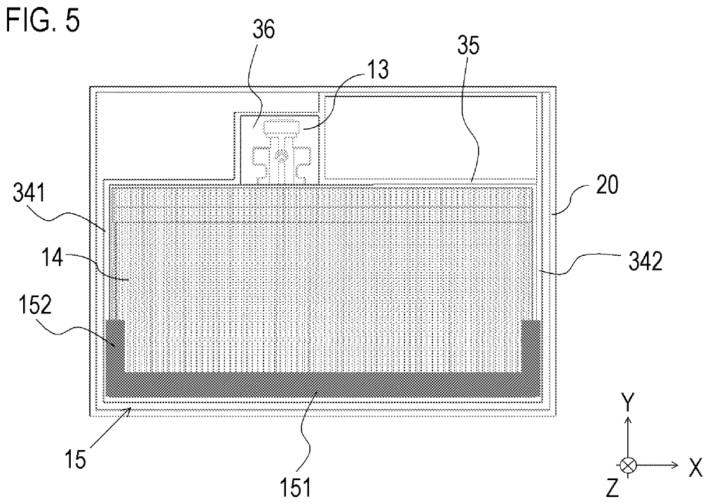

A second embodiment will now be described. Detailed descriptions of the configurations that are the same as those in the first embodiment will be omitted. FIG. 5 is a top view illustrating an internal structure of a cartridge 10 according to a second embodiment. In FIG. 5, the sealing member 12 and the cover 19 are not illustrated.

In the second embodiment, the restricting portion 15 includes a first restricting portion 151 projecting from one end portion of the lower wall 33 in the Z direction toward the inner side of the storage portion 31 in the Y direction, in the same manner as in the first embodiment. The restricting portion 15 also includes second restricting portions 152 projecting from end portions of the first side wall 341 and the second side wall 342 in the Z direction, respectively, toward the inner side of the storage portion 31 in the X direction. The second restricting portions 152 are interposed between the second welded portion 18 and the sealing member 12, and restrict the movement of the second welded portion 18 toward the sealing member 12. The second restricting portions 152 may be provided to lower parts of the first side wall 341 and the second side wall 342 (parts on the side closer to the lower wall 33 in the Y direction).

The warpage of the ink bag 14, resultant of the consumption of the ink inside the ink bag 14, is caused by the entire ink bag 14 becoming rounded up toward the outlet 16. With the configuration according to the second embodiment, it is possible to suppress not only the movement of the longitudinal sides of the second welded portion 18 (in the X direction) but also the movements of the transverse side of the gusseted portion (Y direction). Therefore, the movement of the second welded portion 18 can be suppressed more reliably, and it is possible to suppress the risk of the tip 32 of the second welded portion 18 coming into contact with the sealing member 12, due to warpage of the ink bag 14 caused by the consumption of the ink inside the ink bag 14, more reliably.

### Third Embodiment

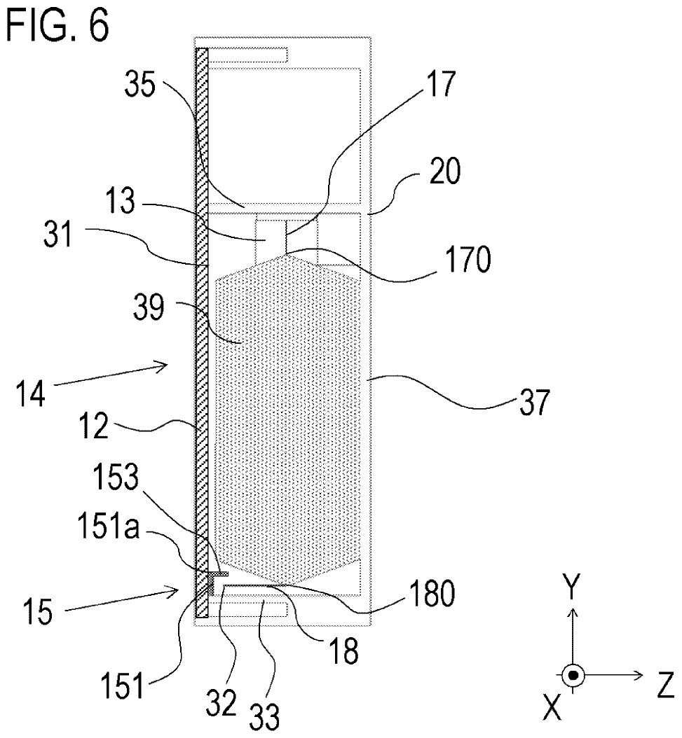

A third embodiment will now be described. Detailed descriptions of the configurations that are the same as those in the first and the second embodiments will be omitted. FIG. 6 is a cross-sectional view illustrating an internal structure of a cartridge 10 according to a third embodiment. The cross-sectional view in FIG. 6 is a cross-sectional view taken at the same position as the line AA in FIG. 3. In FIG. 6, the cover 19 is not illustrated.

In the third embodiment, the restricting portion 15 has a first restricting portion 151 projecting from an end portion of the lower wall 33 in the Z direction toward the inner side of the storage portion 31, in the same manner as the first embodiment. The restricting portion 15 also includes a third restricting portion 153 projecting from an end portion 151a of the first restricting portion 151 (an end portion on the side of the upper wall 35 (the side of the first inner wall surface) in the Y direction, toward the inner side of the storage portion 31 in the Z direction.

With the presence of the third restricting portion 153, the movement of the tip 32 of the second welded portion 18 in the Y direction is restricted. In this manner, it is possible to suppress shrinkage of the ink bag 14 toward the outlet 16 (Y direction) when the ink inside the ink bag 14 decreases. In this manner, it is not only possible to prevent the tip 32 of the second welded portion 18 from coming into contact with the sealing member 12 while the ink bag 14 is stored inside the casing 20, but also to suppress the tip 32 from coming into contact with the sealing member 12 due to the warpage of the ink bag 14 when the ink inside the ink bag 14 decreases.

### Fourth Embodiment

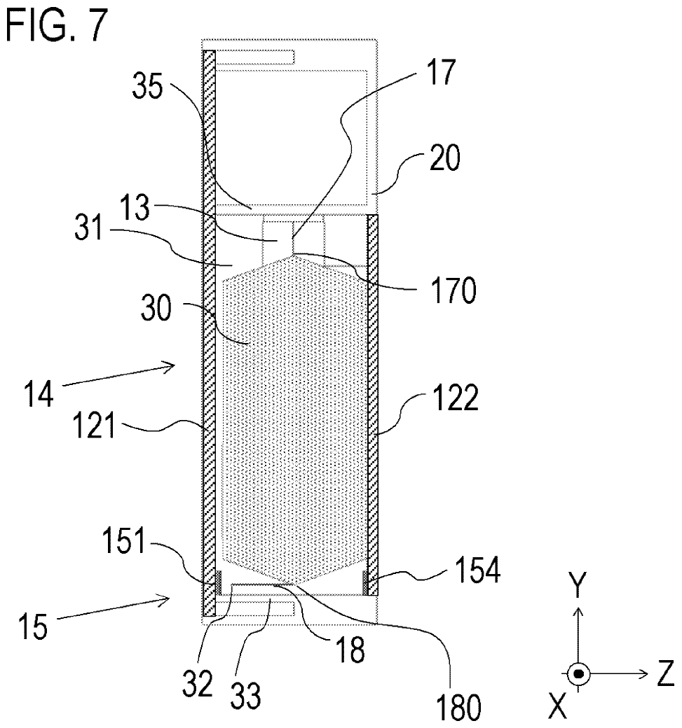

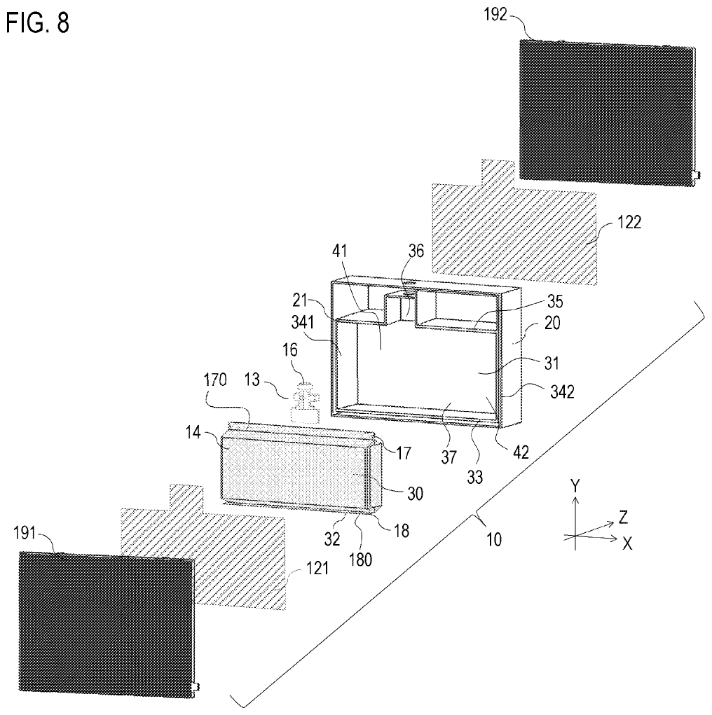

A fourth embodiment will now be described. Detailed descriptions of the configurations that are the same as those in the first, second, and third embodiments will be omitted. FIG. 7 is a cross-sectional view illustrating an internal structure of a cartridge 10 according to the fourth embodiment. The cross-sectional view in FIG. 7 is a cross-sectional view taken at the same position as the line AA in FIG. 3. FIG. 8 is an exploded view of the cartridge 10 according to the fourth embodiment. In FIG. 7, the cover 19 is not illustrated.

In the fourth embodiment, the housing 11 of the cartridge 10 has a casing 20 having openings on both sides in the Z direction, a first cover 191 as a lid member covering one of the openings of the casing 20, and a second cover 192 as a lid member covering the other one of the openings. The storage portion 31 of the casing 20 has a first opening 41 on one side of the ink bag 14 in the thickness direction (Z direction), and a second opening 42 on the other side. A first sealing member 121 is welded to an end face 21 around the first opening 41, and a second sealing member 122 is welded to an end face around the second opening 42, thereby forming the storage portion 31 for the ink bag 14, which is a sealed space, inside the casing 20.

In the fourth embodiment, the restricting portion 15 includes a first restricting portion 151 projecting from one end portion of the lower wall 33 in the Z direction toward the inner side of the storage portion 31 in the Y direction, in the same manner as in the first embodiment, and a fourth restricting portion 154 projecting from the other end portion toward the inner side of the storage portion 31 in the Y direction. The first restricting portion 151 is interposed between the second welded portion 18 and the first sealing member 121, and restricts the movement of the second welded portion 18 toward the first sealing member 121, in the same manner as in the first embodiment. The fourth restricting portion 154 is interposed between the second welded portion 18 and the second sealing member 122, and restricts the movement of the second welded portion 18 toward the second sealing member 122. With this structure, in a configuration in which the casing 20 is sealed by the first sealing member 121 and the second sealing member 122, it is possible to suppress the risk of the tip 32 from coming into contact with the first sealing member 121 and the second sealing member 122, regardless of the direction in which the second welded portion 18 of the ink bag 14 is folded.

According to the present disclosure, even if the liquid storing bag with the welded portion thereof folded deforms inside the casing of the cartridge as the liquid is consumed, it is possible to prevent the welded portion from coming into contact with the sealing member sealing the casing.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-114266, filed on Jul. 17, 2024, which is hereby incorporated by reference herein in its entirety.

What is claimed is:

1. A cartridge comprising:
a liquid storing bag formed by welding an elastic member into a bag-like shape;
a casing including a storage portion enabled to store the liquid storing bag; and
a sealing member configured to seal an opening of the storage portion,
wherein the cartridge is enabled to supply liquid stored in the liquid storing bag to outside,
wherein the storage portion has a first inner wall surface and a second inner wall surface facing the first inner wall surface,
wherein the liquid storing bag includes:
a first welded portion formed to be provided to a first side facing the first inner wall surface;
a second welded portion formed to be provided to a second side facing the second inner wall surface; and
an outlet provided in the first welded portion and enabled to guide the liquid to the outside,
wherein the outlet is fixed to the first inner wall surface, and
wherein the second inner wall surface is provided with a first restricting portion projecting toward an inner side of the storage portion, and interposed between the second welded portion and the sealing member, and moreover configured to restrict a movement of the second welded portion toward the sealing member.

2. The cartridge according to claim 1,
wherein the storage portion has, in a thickness direction of the liquid storing bag, a second opening on another side of the storage portion,
the cartridge further comprising a second sealing member sealing the second opening, and
wherein the second inner wall surface is provided with a fourth restricting portion, and the fourth restricting portion projects toward the inner side of the storage portion, and interposed between the second welded portion and the second sealing member, and moreover configured to restrict a movement of the second welded portion in a direction toward the second sealing member.

3. The cartridge according to claim 1,
wherein the liquid storing bag is stored inside the storage portion in a state where the second welded portion folded along the second side toward the sealing member.

4. The cartridge according to claim 3,
wherein the first restricting portion projects further toward the first inner wall surface than a position of a tip of the second welded portion folded toward the sealing member.

5. The cartridge according to claim 1,
wherein a gap larger than a size of the liquid storing bag in a thickness direction of the liquid storing bag is configured between an end portion of the first restricting portion and the first inner wall surface, the end portion being an end portion on a side of the first inner wall surface.

6. The cartridge according to claim 1,
wherein the first restricting portion is provided continuously along the second side.

7. The cartridge according to claim 1,
wherein a plurality of the first restricting portions is provided along the second side, with a space between the plurality of first restricting portions.

8. The cartridge according to claim 1,
wherein the storage portion has a third inner wall surface extending in a direction intersecting with the first inner wall surface and the second inner wall surface, and a fourth inner wall surface facing the third inner wall surface,
wherein a second restricting portion is provided to at least one of the third inner wall surface and the fourth inner wall surface, and the second restricting portion projects toward an inner side of the storage portion, and interposed between the second welded portion and the sealing member, and moreover configured to restrict a movement of the second welded portion toward the sealing member.

9. The cartridge according to claim 8,
wherein the second restricting portion is provided only to a part of a side thereof closer to the second inner wall surface.

10. The cartridge according to claim 1,
wherein a third restricting portion projecting toward an inner side of the storage portion is provided to an end portion of the first restricting portion, the end portion being an end portion on a side of the first inner wall surface.

11. The cartridge according to claim 1,
wherein the storage portion has, in a thickness direction of the liquid storing bag, the opening on one side of the storage portion.

12. The cartridge according to claim 2,
wherein the storage portion has, in the thickness direction of the liquid storing bag, the opening on one side of the storage portion.
